(19) United States
(12) Patent Application Publication
(10) Pub. No.: US 2021/0230824 A1
(43) Pub. Date: Jul. 29, 2021

(54) DEVICE AND METHOD FOR PREVENTING FLOODS

(71) Applicant: Yevda Yakubov, Nürnberg (DE)

(72) Inventor: Yevda Yakubov, Nürnberg (DE)

(21) Appl. No.: 16/972,453

(22) PCT Filed: Jun. 6, 2018
(86) PCT No.: PCT/IB2018/000599

§ 371 Date: Dec. 4, 2020

(51) Int. Cl. E02B 3/04; F03D 9/00; F03G 6/00; F03G 7/00; F03D 13/20

(52) U.S. Cl. CPC E02B 3/041; F03D 9/00; E02B 9/00; F03G 7/00; F03D 13/20; F03G 6/00

(57) ABSTRACT

The invention relates to a device and a method for preventing floods in the event of a river carrying floodwater. At least one mainline is provided which leads from the region of the floodplain to a collection basin and has one or more pumps in order to pump part of the floodwater through said mainline to the aforementioned collection basin in the event of floodwater, the base of said collection basin lying at a higher level than the riverbed such that electric energy is converted into potential energy of the water during the operation of the at least one pump. According to the method, the electric energy for operating the at least one pump is drawn from a local energy store or is converted in situ from a third energy form which differs from electric energy and hydropower. This is achieved using a device for drawing the electric energy for operating the at least one pump from a local energy store or converting the electric energy in situ from a third energy form which differs from electric energy and hydropower.

### REFERENCE TO PENDING PRIOR PATENT APPLICATION

This patent application claims benefit of International (PCT) Patent Application No. PCT/IB2018/000599, filed 6 Jun. 2018 by Yevda Yakubov for DEVICE AND METHOD FOR PREVENTING FLOODS.

The above-identified patent application is hereby incorporated herein by reference.

### FIELD OF THE INVENTION

The invention relates to a device and a method for preventing floods in the event of a river carrying floodwater, wherein at least one mainline is provided which leads from the region of the floodplain to a collection basin and has one or more pumps in order to pump part of the floodwater through said mainline to the aforementioned collection basin in the event of floodwater, the base of said collection basin lying at a higher level than the riverbed such that electric energy is converted into potential energy of the water during the operation of the at least one pump.

### BACKGROUND OF THE INVENTION

Currently various measures are used to prevent floods in the event of floodwater in a river: The construction of dikes, dams, flood walls, etc., on the one hand, as well as, on the other hand, providing polder areas into which the excess water flows in the event of a floodwater level. The first measure is very expensive, because floodwater naturally extends over many river kilometers and therefore precautionary measures would have to be taken over a great distance. Furthermore, these types of measures are not only costly to develop, they are also very costly in terms of maintenance and repair. In particular, it frequently occurs that dikes, in particular older dikes that have not been maintained to a sufficient extent, quickly give way in serious cases and then break. There is often not enough land area available for polders so that this variant is resigned just to uneven terrain. If an overflow were destined for a lower-lying flood installation, for example with the aid of a bypass channel or flood channel, then it is not possible to direct the water back to the riverbed again using gravity after the floodwater subsides.

In EP 1 067 243 A2 a control shaft is attached laterally next to a flowing body of water, which can fill if the body of water floods its banks. However, this type of control shaft has only a substantially smaller cross-section than the body of water itself and therefore can only take on a small fraction of its water so that this measure is very inefficient and floodwater can only be held back for a very short period of time.

In the event of an extensive floodwater, the energy required to operate the pumps can also cause problems because high-output pumps have a high requirement for energy. If the power supply network becomes overloaded by switching on these types of pumps, this can lead to a longer disruption precisely during the decisive phase.

The disadvantages of the described prior art resulted in the problem that was the impetus for the invention of further developing a device and a method for preventing floods in such a way that an effective protection against floods can also be used in areas with fewer potential polder areas, with great value being placed on the reliability of the system.

### SUMMARY OF THE INVENTION

The solution to this problem is attained as a part of a generic method for preventing floods in the event of a river carrying floodwater, wherein at least one mainline is provided which leads from the region of the floodplain to a collection basin and has one or more pumps in order to pump part of the floodwater to said collection basin in the event of floodwater, the base of said collection basin lying at a higher level than the riverbed such that electric energy is converted into potential energy of the water during the operation of the at least one pump, in that the electric energy for operating the at least one pump is drawn from a local energy store or is converted from a third energy form which differs from electric energy and hydropower.

Thanks to high-performance pumps, collection basins according to the invention can also be situated at a considerably higher level than the riverbed itself. For this reason, the method according to the invention can also be used in particular in narrow valleys or in other bottlenecks. This/these collection basin(s) can in particular also lie in a region of the river that is further upstream or in a tributary valley or neighboring valley of the river valley in question.

After the floodwater recedes and a normal level is reached in the river for example, the water collected in the collection basin can be supplied for another use. For example, it can be used to irrigate agricultural areas, and/or be emptied back into the river. In the latter case in particular, one can make use in the process of the potential energy of the now higher-lying water reservoir, similar to the case with a water power plant, and with the aid of generators extract energy from the water that is flowing back in. For this purpose, if need be, the motors previously used to drive the pumps can now be operated as generators and the power generated in the process can be supplied to the power supply network or be used in another manner. By pumping up the excess floodwater, it is also possible to store a majority of the amount of energy used in the form of potential energy and retrieve it in a controlled manner at a later point in time. As a result, this energy is not lost.

It is also possible to use the water that is temporarily stored in this manner to extract constituents that it contains (for example lime), in particular using filters or the like. This makes sense economically especially if very large quantities of water have been pumped into the collection basin.

The collection basin(s) in an empty state offer(s) other advantages, because it/they can also be used in this case for other purposes, for example as a local recreation area, agricultural area, etc. In the process, it must be taken into consideration that most of the time floodwater occurs only in the early spring, specifically in the case of melting snow, when the areas in question would not yet be used for agricultural purposes. In this case, if applicable, any nutrient-rich sludge that is contained can remain directly on the areas in question after the water has receded and then act as fertilizer.

As a result, it is meaningful if the collection basin(s) is/are natural areas, for example farmland or fields, etc. They should preferably lie in a trough or be surrounded by a barrier for the water. Therefore, the water that is collected therein cannot flow back into the river by itself and remains in the basin(s) in order to be able to be supplied for a subsequent use.

Instead of supplying the floodwater pumps according to the invention from the public power supply network, the electric energy for operating the at least one floodwater pump is drawn from a local energy store or is converted in situ from a third energy form which differs from electric energy and hydropower. The advantage of this is being independent, at least for a critical period of time, of the public power supply network, which is endangered anyway in the event of floodwater, on the one hand, because river water power plants supply almost no energy in the event of floodwater, and furthermore, because power supply line poles can be overturned by torrents of water overflowing the banks and are thereby able to adversely affect the power supply line, and finally, because the floodwater pumps according to the invention would constitute a great additional strain on the public power supply network. In the final analysis, a greater degree of reliability can be achieved in that, i.e., the floodwater pumps also start safely, if needed, and do their job.

The electric energy for operating the at least one pump can be stored as direct current by means of accumulators, in particular if the floodwater protection system to be supplied therewith only requires a limited power. The advantage of storage in accumulators is that the energy is supplied directly as electricity and can also be drawn again directly as electricity.

In the case of larger floodwater protection systems, the invention recommends that the electric energy for operating the at least one pump is stored in the form of a gas, for example in the form of hydrogen gas. Because the storage reservoirs required for this involve a relatively low cost, the additional expense for converting the energy contained into electricity can be cost-effective in the case of larger installations.

The advantage of gas, in particular hydrogen gas, is that it can be produced through electrolysis from water by means of electricity, and that the electric energy can be recovered from the stored gas, preferably hydrogen gas, if needed, by means of at least one fuel cell.

On the other hand, the maintenance costs for a floodwater protection system according to the invention can be further reduced in that the electric energy for operating the at least one pump or for charging the accumulators or for producing a gas by means of electrolysis in situ is produced from wind energy or solar energy or from geothermal energy. As a result, on the one hand, electricity can be saved or the purchase of other sources of energy, and beyond that, if there has been no floodwater for a prolonged period and all energy stores are charged, excess energy from a wind power installation or solar installation or a geothermal system can be supplied to the public power supply network in order to thereby earn money.

Because, on the other hand, the energy used for pumping up to an higher-lying collection level is not lost, but stored as potential energy and when the water flows back into the riverbed after the floodwater situation has improved, due to the generator operation of the pumps activated in the connecting pipes, can be partially recovered in any case, according to the invention, it is furthermore provided to thereby immediately recharge the previously at least partially emptied energy stores, so that the energy can be used again in the event of another floodwater. Even if the energy stores provided for this are only partially charged, the requirement for energy that must be replenished is thereby reduced, which energy is then preferably converted from another form of energy such as wind or solar energy.

The collection basin(s) according to the invention can be filled with the aid of supply lines. In doing so, e.g., several pumps are provided at various locations, in particular at various heights, at a mainline between the floodplain and the collection basin. In the case of an emptied mainline, these pumps should be put into operation one after the other, beginning with the pump nearest to the floodplain in order to prevent a dry operation of the pumps that are situated higher.

In this case, it has proven to be expedient if supply lines are equipped at the inlet, but also, if necessary, at intermediate stations, with collecting sieves or catchment nets. This thereby prevents coarse impurities (e.g., twigs, stones, garbage, fish or the like) from getting into the pipelines and possibly damaging the pumps. This also therefore improves the quality of the pumped water, which can be conveyed subsequently for another use, and is e.g., comparable to rainwater.

A device according to the invention for preventing floods in the event of a river carrying floodwater is characterized by at least one mainline, which leads from the region of the floodplain to at least one collection basin and preferably has one or more pumps. With the aid of this line, which is configured preferably in the form of a pipe (made of concrete, metal, plastic, etc.), excess water is removed from the river in the event of impending floodwater and guided into one or even a plurality of flood basins that are situated at a higher level.

In this connection, the invention provides that to supply the at least one pump with electric energy in situ, i.e., preferably in the region of the collection basin or in the region of the pump(s), a local energy store is provided and/or an apparatus for converting a third energy form, which differs from electric energy and hydropower, to electric energy.

In that at least one energy store designed especially to supply energy to the pumps, as well as a system to convert energy, which system is used, if required, to charge such an energy store or to directly operate the pumps, are both installed in situ, i.e., in close proximity to the pumps, lines or a collection basin, a low-loss supply of energy is ensured, and specifically one that is as independent as possible from the public power supply network. This contributes to the system for floodwater protection also functioning at any time as needed, in particular as independently as possible from an external or public power supply.

In a preferred embodiment, the invention is characterized by accumulators for storing the electric energy in the form of direct current to supply the at least one pump with electric energy. In doing so, the energy is stored chemically. It can then be drawn directly again, if needed, as direct current and must be still be converted as the case may be to alternating or three-phase current to operate the pump(s). For this purpose, electronic inverters can be used as an option, the outputs of which, if necessary, are interconnected to a three-phase current star in order to generate three-phase current, or a mechanical converter is used, consisting of a motor-operated direct current machine and a preferably rigid generator-operated alternating or three-phase current machine that is coupled thereto.

If the required amount of energy for chemical storage in accumulators is too great, the invention provides an alternative method of energy storage. This comprises at least one storage reservoir, preferably at least one storage reservoir, for supplying a gas, preferably hydrogen gas, which can be used to supply the at least one pump with electric energy. In the process, the conversion of energy to electricity takes place either directly with at least one fuel cell, or indirectly by combustion in a turbine, to which a power generator is coupled. Methane or natural gas, for example, would be suitable for combustion. Even a liquid like crude oil or heating oil or diesel or gasoline would be suitable as an energy store; however, no pressure reservoirs can be used for this, but tanks.

The advantage of hydrogen, or the methane that can be generated therefrom, is that is can be produced in a simple way, for example by the use of electric energy. Following this inventive thought, the invention is preferably further characterized by an apparatus to produce gas, preferably hydrogen gas, through electrolysis from water by means of electricity, in particular from pure, filtered or distilled water. The electricity used for this can for its part originate from renewable forms of energy such as for example wind or solar energy or geothermal energy. As a result, it is not necessary to purchase expensive diesel or crude oil for the operation of the flood water protection system according to the invention. Beyond this, in years without floodwater, after all reservoirs are completely filled, the excess energy can then be used to supply the public power supply network.

Suited as an apparatus for converting wind energy is preferably a wind power plant, especially in a design with a tower and a wind turbine that is mounted on the upper end thereof in a nacelle so it can rotate around an approximately horizontal axis of rotation. Since all mechanically and electrically important parts of such a wind power plant are arranged on the upper end of the tower, it is possible by all means to set up one or more of these types of wind turbines or wind power plants directly in the area of a collection basin. It would only be necessary to make sure that the entrance hatch is arranged at the lower end of the tower at a raised level, up to which no water can rise even when the collection basin is completely filled, or that the entrance hatch is sealed, or that no moisture-sensitive systems are installed in the lower region of the tower, so that the tower can deliberately run full of water in the lower region.

Photovoltaic installations or solar thermal systems are optionally used to convert solar energy into electric energy. The advantage of the latter is a rather simple construction: A larger number of mirrors arranged on the ground or on a frame are oriented in such a way that that the sunlight reflected by them falls on a vessel set up at an exposed location, where then a medium is heated, with which a steam turbine is then operated. The advantage of such an arrangement is that this type of a mirror field can also be installed directly in a collection basin. If the mirrors are flooded in the event of floodwater, it is not associated with the risk of short circuits. Merely any actuating motors that might be present should be designed to be waterproof.

Even an apparatus for the use of geothermal energy could be installed in the region of a collection basin, i.e., either in the collection basin itself or on the rim thereof. If necessary, such a system can be sealed.

The pumps should preferably be operated such that the pressure in the main pipe does not exceed a value of 20 atm. at any location of the mainline, preferably a value of 15 atm. at any location of the mainline, in particular a value of 10 atm. at any location of the mainline. Otherwise, there would be a risk of rupturing the overloaded mainline.

If the mainline is configured as a pipe, it has proven to be meaningful that it be designed for example with a diameter of 1 m or more, preferably with a diameter of 1.20 m or more, in particular with a diameter of 1.50 m or more. This type of design of the diameter produces a sufficient flow capacity that allows large quantities of liquid to be carried away sufficiently quickly. Depending on the material used for the pipeline, something that likewise applies to the supply lines, it can be meaningful for the pipes to be lined inside or sealed, for example with glass, paint, adhesive, enamel, etc. to achieve the most laminar, turbulent-free flow possible and/or a reduction of knocking during transit.

The mainline can run over a longer segment approximately parallel to the river, in particular in the flood plain thereof. However, the guidance of the (main)line(s) in individual cases should always be adapted to the geographic peculiarities. In particular, the slope of the terrain, type of substrate, etc. are factors that influence the guidance of the pipe(s). The pipes can also be guided above ground or subterraneously.

The mainline(s) can run to the river over a length of 500 m or more (parallel), for example over a length of 1 km or more, preferably over a length of 2 km or more, in particular over a length of 5 km or more. This long guidance of the mainline can be meaningful, if a suitable region for a flood basin is not available in the direct proximity of the river. It is preferably desired that the flood basin has a natural substrate, that it is not necessarily an asphalted area or another region that is not used for agriculture. Furthermore, it is advantageous if the selected flood basin constitutes a trough or is surrounded by a wall or dike. As a result, the pumped water does not run away and is available for a subsequent use.

It is within the framework of the invention that a plurality of connecting lines, in particular connecting pipes, are laid between the river and the section of the mainline that is parallel thereto. These connecting pipes remove water at different river segment regions and therefore rectify the flood situation rapidly and effectively.

These connecting pipes, which convey the water to the mainline, should have a diameter of 500 mm or more, preferably of 600 mm or more, in particular of 750 mm or more. This allows a rapid outpouring to be achieved from the riverbed into the mainline according to the invention.

In this case, every connecting pipe should comprise at least one separate pump in order to pump out water from the river depending on the specification and to convey water into the mainline even against a gradient. The pumps should be easily accessible in order to facilitate easy maintenance and repair. To this end, they could be installed on the pipes for example.

On the other hand, it also corresponds to the teaching of the invention that the connecting pipes are capable of being shut off by means of valves or the like. As a result, the water flow can be influenced in a targeted manner and, in the case of low water, an outflow from the riverbed can be prevented. Because of these closure possibilities, it is possible, depending on the extent of the anticipated floodwater, to regulate how many supply lines must be used to pump out the water from the river. Depending on what is desired or the dimensioning of the system, regulating this can be accomplished manually or even with an electronic control and regulation unit. The flow rate and the pressure in the pipes should then be regulated based on advance calculations or empirical values, taking parameters such as width, depth of the river, flow rate in the riverbed, etc. into consideration.

Depending on the extent of the floodwater, a conceivable scenario would be to pump for only a limited period of time, for example during 5 h (continuously), until the crest of the anticipated floodwater has been overcome.

A reasonable pumping speed in the mainline pipe can be regulated to 1-2 m/s for example. The flow rate in the connecting pipes having a smaller diameter can then be 0.5-1 m/s for example, i.e., in a ratio of 2 to 1.

As a result, it is possible to divert quantities of water in an order of magnitude of 40,000 m³ and greater from the river and thereby prevent a flood in a nearby city, village, factory, industry.

The system according to the invention explained here is simple and cost-effective in terms of the installation, so that it can also be included as a part of planned, new construction projects in urban planning.

### BRIEF DESCRIPTION OF THE DRAWINGS

Additional features, details, advantages and effects based on the invention are yielded from the following description of a preferred embodiment of the invention as well as based on the drawing, which shows:

FIG. 1 A first arrangement for protecting the areas adjacent to a river optionally carrying floodwater from the negative effects of floodwater; and

FIG. 2 Another arrangement to preserve areas in a region of the river carrying floodwater from damage in the event of floodwater.

### DETAILED DESCRIPTION OF THE PREFERRED EMBODIMENTS

The drawing depicts a river 1, which can potentially produce floodwater in special situations, for example in the case of melting snow. The reference number 2 identifies its normal direction of flow.

In a region that is endangered by floodwater, it is preferred that several lines 3 branch off from the river 1, each of which is always equipped with at least one pump 4. These pumps 4 are used to suction off excess water from the river 1 in the event of a floodwater and transport it in the direction of a higher-lying mainline 5, which in this case runs parallel to the river 1.

The mainline 5 is likewise equipped with one or more pumps 4, which transport the water in the mainline in the direction of a collection basin 6, in which it can be stored.

The water remains in the collection basin 6 until the floodwater situation has improved substantially, and then can be redirected back to the riverbed 1 gradually, in particular if electricity is currently needed. In the process, the motors of the pumps 4 can be used as generators and the pumps 4 themselves as turbines, in order to generate electricity from the potential energy of the water and to supply said electricity to the power supply network, for storage or to be used otherwise.

Then, the sludge carried along by the water collects on the bottom of the collection basin 6 in question and in the subsequent growing season is used as a natural fertilizer in order to increase the yield of the relevant agricultural areas.

With the previously described system, it is possible to avert the risk of floodwater even in narrow valleys without the possibility of a polder, by pumping the excess water temporarily to a higher-lying level.

However, energy in particular three-phase current is required to operate the pumps 4. This energy is normally drawn from the public power supply network. However, especially in the region of larger rivers, energy for supplying the public power supply network is often derived from waterpower plants, which, however, in the case of floodwater, only provide a severely diminished level of power. If the power supply network is overloaded and collapses because of the concurrence of these events in the case of floodwater —lower electricity generation from hydropower, on the one hand, and increased demand for electricity to pump out the floodwater wave, on the other hand—then the system that was actually designed to protect against floodwater will fail at the crucial moment, because the pumps 4 are not supplied with electricity.

In order to be forearmed against this worst case, the invention provides for the pumps 4 according to the invention to be supplied primarily by neither the public power supply network nor by hydropower. Because precisely these forms of energy are relatively uncertain in the event of floodwater and therefore endanger the reliability of the system according to the invention.

Instead a first embodiment provides that an energy store be provided to supply the pumps 4, for example in the form of at least one system 7 having accumulators for the chemical storage of electricity. This type of system 7 can be situated in the direct proximity of the pumps 4. The charging capacity of such a system 7 should be designed so that a multi-hour operation of pumps 4 is ensured, for example for at least 12 hours, preferably for at least 24 hours, in particular for at least 36 hours. Furthermore, it must be ensured that the stored amount of energy always corresponds to at least half or at least two thirds of the maximum charging capacity or to preferably at least three quarters of the maximum charging capacity.

The electricity flowing out of this type of electricity storage system 7 is normally direct current to begin with, which must be converted into an alternating current or three-phase current to supply the powerful pumps 4. Inverters can be used for this. On the other hand, it would also be possible to drive a three-phase current generator with a powerful direct current motor, which then supplies the pumps 4; finally the pumps 4 could also be designed as direct current pumps.

So that charging such an electricity storage system 7 does not burden the public power supply network, the invention furthermore provides that the accumulators of an electricity storage system 7 according to the invention are not charged by the power supply network, but by means of renewable energies. The form of energy that is primarily recommended in this case would be wind energy, because it is available to a an increasing degree especially at higher elevations where most of the time a system according to the invention is installed. One could therefore set up one or preferably more wind turbines 8 in the proximity of a system according to the invention and supply the energy therefrom to the electricity storage system 7, and, once it is fully charged, supply the electricity that can no longer be accommodated to the public power supply network.

Even though this is not mandatory, the necessary wind power plants 8 could be set up in the process in the region of a collection basin 6 or even directly in such a collection basin 6. In standby mode, there is indeed no water in a collection basin 6 so that the wind power plants 8 located there are accessible via dry ground and can be serviced regularly. If the collection basin 6 in question is then flooded in the event of floodwater then the pedestals of the towers 9 of the wind power plants 8 might be standing in several meters of water, which is not a big problem though.

However, for this case, the access door to a wind power plant 8 could be positioned at a correspondingly high level, i.e., several meters above the level of the landscape with a dry collection basin 6, in particular above the maximum water level in the relevant collection basin 6 in the event of floodwater. Then special sealing measures are not required, which otherwise would have to be observed so that no water can penetrate into the tower.

In addition, if the power supply lines leading away from such a wind power plant 8 are likewise guided at a level above the maximum water level in the relevant collection basin 6 up to the rim thereof, for example in the form of a power supply line suspended on a pole, there is no danger of a short circuit from water, and in such a case the pedestal of a wind power plant could even be designed in such a way that, when the relevant collection basin 6 is flooded, it runs full of water, which is able to drain off again when the collection basin 6 empties. One advantage in this case would be that the empty tower pedestal is not subject to any buoyancy force and therefore the anchoring of the wind power plant 8 is ensured even when the collection basin 6 is flooded.

When the collection basin 6 is flooded, the maintenance personnel would come by a boat to the pedestal of a power plant 8, if a higher-lying bridge does not lead to the wind power plant 8 from the rim or banks of the collection basin 6.

A wind power plant 8 can also continue to generate electricity when the collection basin 6 is flooded and, as a result, refill the electricity storage system 7 again so that, in an ideal case, the service life of the pumps 4 is longer than would be anticipated in accordance with the charging capacity of the electricity storage system 7.

Solar energy also would also be considered for supplying the electricity storage system 7, wherein, however, photovoltaic modules should be arranged inside the collection basin 6, only if short circuits of all kinds are ruled out when the collection basin 6 is flooded.

Therefore, in general in the case of a flooded basin 6, an operation of the solar installation and therefore a refilling of the electricity storage system 7 are not possible in the event of floodwater.

The same applies for a replenishment of the electricity storage system 7 using hydropower, because in the event of floodwater most of the time this is available only to a limited extent or not at all.

If, in the event of floodwater, the electricity storage 7 gradually dwindles and also can no longer be recharged adequately by wind energy, it is also possible to fall back on the public power supply network if need be. Often the maximum level of the floodwater has already been exceeded by then and all pumps 4 do not need to run simultaneously anymore so that the public power supply network is spared nevertheless.

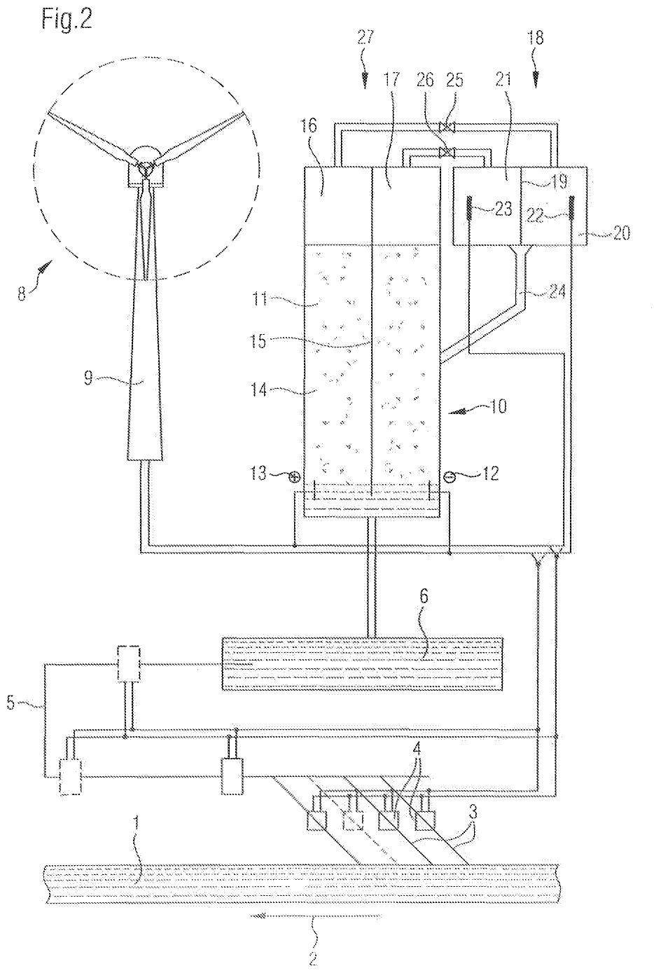

If calculations for a project according to the invention show that realizing the electricity storage system 7 by means of accumulators entails undesired high costs because of a high required charging capacity, there is the possibility of realizing a system such as the one depicted in FIG. 2.

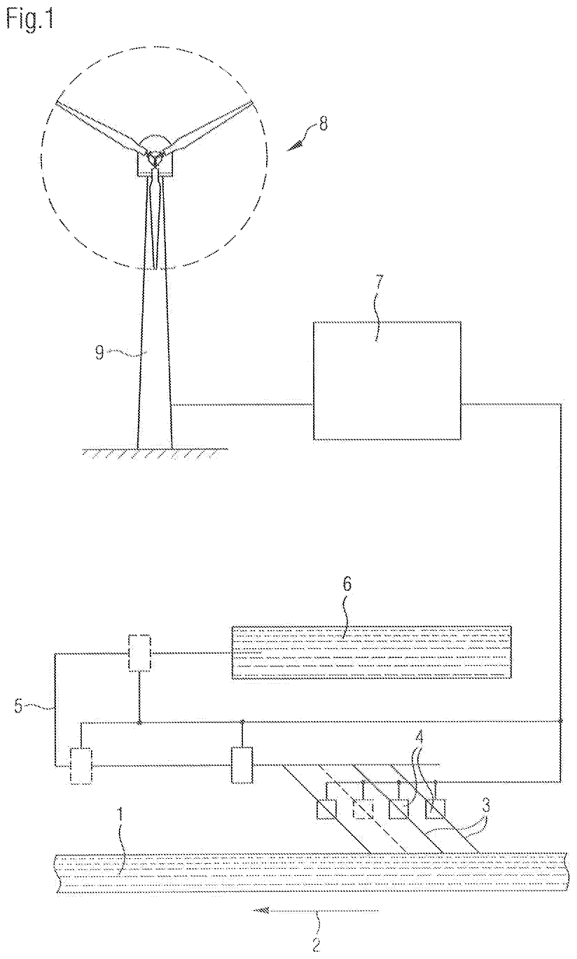

In this case, the supply pipes 3 having pumps 4, the mainline pipe 5, the collection basin 6 and the wind power plant 8 can be realized like the system in FIG. 1; only the electricity storage system 7 is replaced or supplemented by a special design, which can be seen in FIG. 2.

In contrast to the circuit diagram according to FIG. 1, the positive and negative poles of a direct current system are depicted separately from each other in FIG. 2.

FIG. 2 shows that the electricity generated from wind energy in the wind turbine 8 is made available as direct current. It is supplied to an electrolysis plant 10, where an electrolyte 11, in particular distilled water H₂O, is converted by means of direct current into hydrogen H₂ and oxygen O₂. In the process, the hydrogen H₂ bubbles upward at the cathode 12, and the oxygen O₂ at the anode 13. In a region above the cathode 12 and anode 13 separated spatially from each other in the horizontal direction, the space 14 of the electrolysis plant 10 which accommodates the aqueous electrolytes 11 is divided by a separating wall 15 into a first collection space 16 for the hydrogen H₂ and a second collection space 17 for the oxygen O₂.

Because these collections spaces 16, 17 can be built to be any size, large quantities of hydrogen H₂ and oxygen O₂ can be stored. In order to rapidly recover the energy stored therein if required, at least one fuel cell 18 is provided which has two chambers 20, 21 separated from each other by a membrane 19, and said chambers can be filled with hydrogen H₂, on the one hand, and with oxygen O₂, on the other, from the collection spaces 16, 17.

The membrane is configured such that it allows only ions to pass through, for example only protons H⁺. So that the protons H⁺ can nevertheless combine with the oxygen O₂ to form water H₂O, every proton H⁺ still needs an electron. However, the electrons are forced flow through a pipeline network attached to electrodes 22, 23 inside the chambers 20, 21, whereby they are able to perform work.

In particular, the electrodes 22, 23 can be used together with supply lines to supply the pumps 4. The water accumulating in the fuel cell 18 can be fed back to the electrolysis plant 10 via a pipe 24.

The generation of electricity within the fuel cell 18 can be controlled by valves 25, 26, which influence, in particular allow or block, the inflow of O₂ and H₂ from the collection spaces 16, 17 into the chambers 20, 21 of the fuel cell 18.

In the case of the depicted embodiment, instead of large chemical accumulators, only an unlimited number of large pressure vessels 16, 17 must be set up to collect hydrogen H₂ and oxygen O₂. If the fuel cell 18 is in a position to use the oxygen from the air, even the storage of oxygen O₂ can be dispensed with, and only vessels for hydrogen H₂ must be provided.

In order to obtain a sufficient amount of direct voltage if required, it can be necessary to use a plurality of fuel cells instead of a single fuel cell 18 and to connect those in series so that their voltages add up.

When using three-phase current pumps 4 naturally the direct current generated in the fuel cell 18 must first be converted to three-phase current, for example by means of one or more inverters.

An alternating voltage can then be stepped up with little effort in order to reach the voltage amplitude required for the three-phase current pumps 4.

To further support the gas storage system 27, the output voltage of the wind power plant 8 can be attached directly to the output voltage of the fuel cell system 18.

### LIST OF REFERENCE NUMBERS

1 River

2 Direction of flow

3 Supply pipes

4 Pump

5 Mainline pipe

6 Collection basin

7 Electricity storage system

8 Wind power plant

9 Tower

10 Electrolysis plant

11 Electrolyte

12 Cathode

13 Anode

14 Space

15 Separating wall

16 Collection space

17 Collection space

18 Fuel cell

19 Membrane

20 Chamber

21 Chamber

22 Electrode

23 Electrode

24 Pipe

25 Valve

26 Valve

27 Gas storage system

1. A method for preventing floods in the event of a river (1) carrying floodwater, wherein at least one mainline (5) is provided which leads from the region of the floodplain to a collection basin (6) and has one or more pumps (4) in order to pump part of the floodwater to said collection basin (6) in the event of floodwater (6), the base of said collection basin lying at a higher level than the bed of the river (1) so that electric energy is converted into potential energy of the water during the operation of the at least one pump (4), characterized in that the electric energy for operating the at least one pump (4) is drawn from a local energy store or is converted in situ, preferably in the region of the collection basin (6) or the pump(s) (4) from a third energy form which differs from electric energy and hydropower.

2. The method according to claim 1, characterized in that the electric energy for operating the at least one pump (4) is stored as direct current by means of accumulators.

3. The method according to claim 1, characterized in that the electric energy for operating the at least one pump (4) is stored in the form of a gas, for example in the form of hydrogen gas.

4. The method according to claim 3, characterized in that the gas, for example the hydrogen gas, is produced through electrolysis from water by means of electricity.

5. The method according to claim 3, characterized in that electric energy can be produced from the stored gas, preferably hydrogen gas, if needed, by means of at least one fuel cell.

6. The method according to claim 1, characterized in that the electric energy for operating the at least one pump (4) or for charging the accumulators or for producing a gas by means of electrolysis in situ is produced from wind energy or solar energy or from geothermal energy.

7. The method according to claim 6, characterized in that an apparatus for converting wind energy into electric energy is constructed as a wind power plant, consisting of a tower and a wind turbine arranged movably thereon.

8. The method according to claim 1, wherein several pumps (4) are provided at various locations, in particular at various heights, in a mainline between the floodplain and the collection basin (6), characterized in that the pumps (4) are put into operation one after the other in the case of an emptied mainline (5), beginning with the pump (4) nearest to the floodplain.

9. A device for preventing floods in the event of a river (1) carrying floodwater, with at least one mainline (5), which leads from the region of the floodplain to a collection basin (6) and has one or more pumps (4) in order to pump part of the floodwater to said collection basin (6) in the event of floodwater, the base of said collection basin lying at a higher level than the bed of the river (1) so that electric energy is converted into potential energy of the water during the operation of the at least one pump (4), characterized in that to supply the at least one pump (4) with electric energy in situ, preferably in the region of the collection basin (6) or of the pump(s) (4), a local energy store is provided and/or an apparatus for converting a third energy form, which differs from electric energy and hydropower, to electric energy.

10. The device according to claim 9, characterized by accumulators for storing the electric energy in the form of direct current to supply the at least one pump (4) with electric energy.

11. The device according to claim 9, characterized by at least one storage reservoir, preferably at least one pressure storage reservoir, for storing a gas, preferably hydrogen gas, to supply the at least one pump (4) with electric energy.

12. The device according to claim 11, characterized by an apparatus to produce gas, preferably hydrogen gas, through electrolysis from water by means of electricity, in particular from pure, filtered or distilled water.

13. The device according to claim 9, characterized by at least one apparatus installed in situ, preferably in the region of the collection basin (6) or the pump(s) (4), for generating electric energy to operate the at least one pump (4) or to charge the accumulators or to produce a gas by means of electrolysis, from wind energy or solar energy or from geothermal energy.

14. The device according to claim 13, characterized in that the at least one apparatus for converting wind energy or solar energy or geothermal energy into electric energy is located in the region of a collection basin (6), preferably in the collection basin (6) itself, if necessary, protected from moisture by a pedestal or other supports or by bulkheads.

15. The device according to claim 9, characterized in that an apparatus for converting wind energy into electric energy is constructed as a wind power plant, consisting of a tower and a wind turbine arranged movably thereon.
